(19) United States
(12) Patent Application Publication
(10) Pub. No.: US 2011/0037882 A1
(43) Pub. Date: Feb. 17, 2011

(54) Solid-state imaging device, method of driving solid-state imaging device, and electronic apparatus

(75) Inventors: Manabu Kukita, Fukuoka (JP); Naoki Hayashi, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/805,157

(22) Filed: Jul. 15, 2010

(30) Foreign Application Priority Data
Aug. 11, 2009 (JP) 2009-186249

(51) Int. Cl. H04N 9/64

(52) U.S. Cl. 348/246; 348/E09.037

(57) ABSTRACT

A solid-state imaging device includes: an imaging unit, in which unit pixels each including a photoelectric conversion device are disposed two-dimensionally, that has an effective pixel portion and an ineffective pixel portion where light is incident and not incident to the photoelectric conversion device, respectively; a pixel-signal reading circuit unit reading out a pixel signal acquired by the imaging unit; a correction value calculating unit calculating a correction value for the pixel signals of the ineffective pixel portion for each column that are read out by the pixel-signal reading circuit unit by averaging the pixel signals of pixels disposed along a horizontal direction of the ineffective pixel portion; and a difference calculating unit subtracting the correction value corresponding to a column of the effective pixel portion, calculated by the correction value calculating unit, from the pixel signal of the effective pixel portion read out by the pixel-signal reading circuit unit.

### BACKGROUND OF THE INVENTION

1. Field of the Invention

The present invention relates to a solid-state imaging device, a method of driving a solid-state imaging device, and an electronic apparatus, and more particularly, to a solid-state imaging device, a method of driving a solid-state imaging device, and an electronic apparatus that perform correction of a pixel signal fetched in an effective pixel portion by using a pixel signal fetched in an ineffective pixel portion.

2. Description of the Related Art

In related art, as described in JP-A-2008-124527 and JP-A-10-126697, there are technologies for detecting a correction signal by using a dummy circuit for shading correction in a solid-state imaging device. In addition, in JP-A-2007-336343, a technology for performing the shading correction by using a signal of a VOPB (optical black for the V(vertical) direction) portion, which has the same configuration as an effective pixel portion, as a correction signal is disclosed.

### SUMMARY OF THE INVENTION

According to the related arts described in JP-A-2008-124527 and JP-A-10-126697, a vertical line or shading due to a circuit can be corrected. However, there are cases where it is difficult to correct a defect due to a pixel, and accordingly, a signal read out by using the same configuration as the effective pixel portion may need to be detected as a correction signal. In addition, according to the technology described in JP-A-2007-336343, there is a disadvantage in that a vertical line is formed after correction due to white dots and white sesame dots of the VOPB. In order to avoid such problems, there is a technique in which the influence of white dots and white sesame dots is avoided by using the VOPB portion in the read-out OFF state while generating a correction signal from the same circuit configuration. However, there are problems in that it is difficult for the technology to respond to a case where it is desired to eliminate a pixel dark current component and there is the influence of a difference in the H (Horizontal) shading shape due to a difference in a read-out operation for not reading out a pixel signal and the like.

Thus, it is desirable to provide a technology for performing shading correction with generation of a vertical line caused by white dots or white sesame dots of the ineffective pixel portion being avoided while a signal is read out by performing the same operation as that of the effective pixel portion by using the ineffective pixel portion.

According to an embodiment of the present invention, there is provided a solid-state imaging device including: an imaging unit, in which a plurality of unit pixels each including a photoelectric conversion device are disposed in a two-dimensional shape, that has an effective pixel portion in which light is incident to the photoelectric conversion device and an ineffective pixel portion in which light is not incident to the photoelectric conversion device; a pixel-signal reading circuit unit that reads out a pixel signal acquired by the imaging unit; a correction value calculating unit that calculates a correction value for the pixel signals of the ineffective pixel portion for each column that are read out by the pixel-signal reading circuit unit by averaging the pixel signals of a plurality of pixels that are disposed along a horizontal direction of the ineffective pixel portion; and a difference calculating unit that subtracts the correction value corresponding to a column of the effective pixel portion, which is calculated by the correction value calculating unit, from the pixel signal of the effective pixel portion that is read out by the pixel-signal reading circuit unit. In addition, according to another embodiment of the present invention, there is provided an electronic apparatus using the above-described solid-state imaging device.

According to the embodiments of the present invention, when a correction value used for shading correction is acquired for each column, for the pixel signals of the ineffective pixel portion corresponding to a corresponding column, an average of pixel signals of several pixels disposed along the horizontal direction is calculated so as to be used as a correction value. Accordingly, even when there is influence of white dots or white sesame dots on the ineffective pixel portion corresponding to the corresponding column, the influence can be scattered by averaging the pixel signals of several pixels disposed along the horizontal direction.

Here, in the viewpoint of performing H shading, the several pixels disposed along the horizontal direction corresponds to the number of pixels from which a level change in the pixel signals along the horizontal direction can be acquired. For example, the number of pixels is in the range of 3 to 127, and is more preferably in the range of 3 to 15.

According to still another embodiment of the present invention, there is provided a method of driving a solid-state imaging device. The method includes the steps of: acquiring a pixel signal by using an imaging unit, in which a plurality of unit pixels each including a photoelectric conversion device are disposed in a two-dimensional shape, that has an effective pixel portion in which light is incident to the photoelectric conversion device and an ineffective pixel portion in which light is not incident to the photoelectric conversion device; calculating a correction value by reading out the pixel signals acquired by the ineffective pixel portion of the imaging unit and averaging the pixel signals of a plurality of pixels disposed along a horizontal direction of the ineffective pixel portion; and reading out the pixel signals acquired by the effective pixel portion of the imaging unit and subtracting the correction value corresponding to a corresponding column of the effective pixel portion from the pixel signals.

According to the embodiment of the present invention, when a correction value used for shading correction is acquired for each column, for the pixel signals of the ineffective pixel portion corresponding to a corresponding column, an average of pixel signals of several pixels disposed along the horizontal direction is calculated so as to be used as a correction value. Accordingly, even when there is influence of white dots or white sesame dots on the ineffective pixel portion corresponding to the corresponding column, the influence can be scattered by averaging the pixel signals of several pixels disposed along the horizontal direction.

According to the embodiments of the present invention, in order to detect a vertical line over several columns, the influence of white dots, white sesame dots, and a fixed pattern noise on a detection value of the vertical line can be decreased based on a low pass filter effect for the horizontal direction. Accordingly, the H shading correction can be performed without deteriorating the vertical line by taking the signal in the state in which the ineffective pixel portion is operated.

### BRIEF DESCRIPTION OF THE DRAWINGS

FIG. 1 is a schematic plan view illustrating an example of the entire configuration of a solid-state imaging device according to this embodiment.

FIG. 2 is a circuit diagram showing an example of the circuit configuration of a pixel.

FIG. 3 is a timing chart illustrating the output timing of a pixel signal in a method of driving a solid-state imaging device according to this embodiment.

FIG. 4 is a schematic diagram illustrating a method of calculating a correction value according to a comparative example.

FIG. 5 is a schematic diagram illustrating a method of calculating a correction value according to this embodiment.

FIG. 6 is a block diagram showing a configuration example of an imaging apparatus as an example of an electronic apparatus according to this embodiment.

### DESCRIPTION OF THE PREFERRED EMBODIMENTS

Hereinafter, mode for implementing the present invention (hereinafter, referred to as “embodiments”) will be described. The description will be presented in the following order.

1. Structure of Solid-State Imaging Device (Example of Two-Dimensional Structure, Circuit Configuration, and Correction Value Calculating Unit)

2. Method of Driving Solid-State Imaging Device (Example of Read Timing of Pixel Signal, Method of Calculating Correction Value, and Concrete Method of Column Addition)

3. Electronic Apparatus (Configuration Example of Imaging Apparatus)

### <1. Structure of Solid-State Imaging Device>

[Two-Dimensional Structure of Solid-State Imaging Device according to Embodiment]

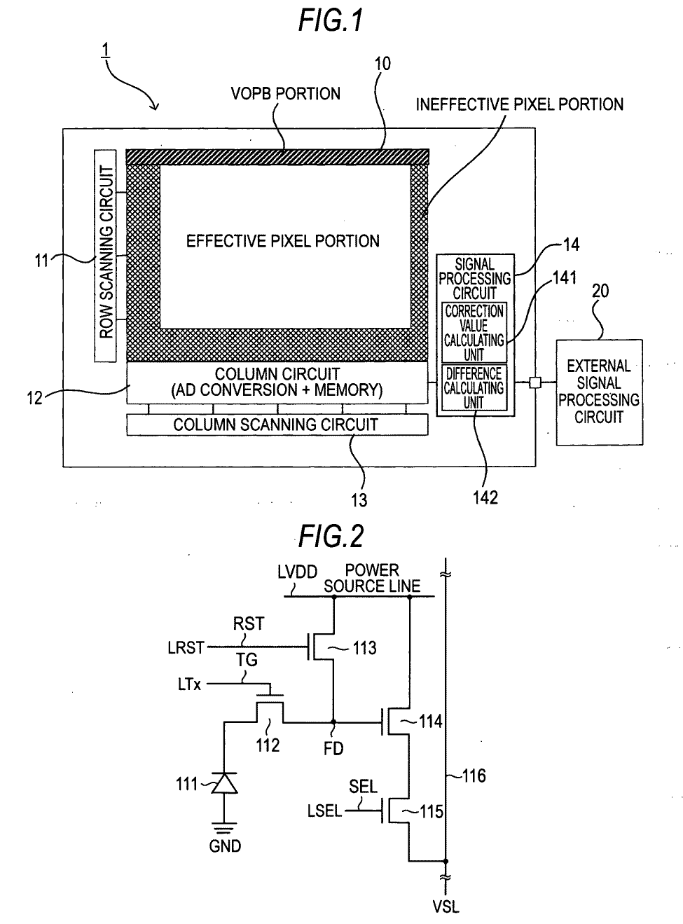

FIG. 1 is a schematic plan view illustrating an example of the entire configuration of a solid-state imaging device according to this embodiment. The solid-state imaging device 1 includes an imaging unit 10, a row scanning circuit 11, a column circuit 12, a column scanning circuit 13, and a signal processing circuit 14.

The imaging unit 10 has a configuration in which a plurality of unit pixels each including a photoelectric conversion device (photo diode) are disposed in a two-dimensional shape. The imaging unit 10 includes an effective pixel portion in which light is incident to the photoelectric conversion device thereof and an ineffective pixel portion in which light is not incident to the photoelectric conversion device thereof. Here, the ineffective pixel portion is disposed in a necessary position located on the periphery of the effective pixel portion. In the ineffective pixel portion, a light shielding film that screens the photoelectric conversion device is disposed, and thereby incidence of external light is blocked.

The row scanning circuit 11 is a circuit that selects pixels in units of one row and sequentially scans the selected pixels along the vertical direction. Signals (pixel signals) acquired from pixels in units of one row selected by the row scanning circuit 11 are transmitted to the column circuit 12 through a vertical signal line not shown in the figure.

The column circuit 12 is a circuit that processes a pixel circuit that is transmitted through the vertical signal line. The column circuit 12 includes an AD conversion circuit that converts a transmitted analog pixel signal into a digital signal and a memory that temporarily stores a signal to be processed.

The column scanning circuit 13 is a circuit that sequentially selects pixels along the horizontal direction in synchronization with scanning performed by the row scanning circuit 11. The column scanning circuit 13 transmits the pixel signals, which are sequentially transmitted to the column circuit 12 through the vertical signal line in the order of selection and are converted into digital signals by the column circuit 12, to the signal processing circuit 14. The column scanning circuit 13 and the row scanning circuit 11 forms a pixel signal reading circuit unit that reads out the pixel signal.

The signal processing circuit 14 is a circuit that performs various signal processes for the pixel signal transmitted through the column circuit 12 and outputs the processed signal.

In the solid-state imaging device 1 according to this embodiment, a correction value calculating unit 141 that calculates a correction-value used for performing shading correction for the pixel signal and a difference calculating unit 142 that acquires a signal for which shading correction is performed by subtracting the correction value calculated by the correction value calculating unit 141 from the pixel signal are included. In FIG. 1, the correction value calculating unit 141 and the difference calculating unit 142 are configured in the signal processing circuit 14. However, the correction value calculating unit 141 and the difference calculating unit 142 may be configured in an external signal processing circuit 20 that is connected to the outside of the chip.

In the above-described solid-state imaging device 1, in this embodiment, a portion that is disposed along the horizontal direction in the end portion of the ineffective pixel portion in the vertical direction is defined as a VOPB (optical black for the V (vertical) direction) portion.

### [Circuit Configuration of Pixel]

FIG. 2 is a circuit diagram showing an example of the circuit configuration of a pixel. The effective pixel portion and the ineffective pixel portion including the VOPB portion use the circuit configuration of the pixel shown in FIG. 2 as a basic unit. The pixel of this circuit example is configured to include a photoelectric conversion device 111 that is a photo diode and four transistors of a transfer transistor 112, a reset transistor 113, an amplifier transistor 114, and a selection transistor 115. As each transistor, for example, an N-channel MOS transistor is used.

Three driving wires of a transmission line TG, a reset line RST, and a selection line SEL are disposed to be common to the pixels positioned in the same pixel row. One end of each of the transmission line TG, the reset line RST, and the selection line SEL is connected to an output terminal of the row scanning circuit (see FIG. 1) that corresponds to each pixel row in units of one pixel row.

The photoelectric conversion device 111 has the anode connected to the negative side of a power source, for example, the ground. The photoelectric conversion device 111 performs photoelectric conversion for converting received light into optical electric charges (here, photo electrons) of the charge amount corresponding to the amount of received light. The cathode electrode of the photoelectric conversion device 111 is electrically connected to the gate electrode of the amplifier transistor 114 through the transfer transistor 112. A node that is electrically connected to the gate electrode of the amplifier transistor 114 forms a floating diffusion FD.

The transfer transistor 112 is connected between the cathode electrode of the photoelectric conversion device 111 and the floating diffusion FD. The transfer transistor 112 is in the ON state by applying a transmission pulse LTx, which has a high level (for example, the level of VDD) being active (hereinafter, referred to as “high active”), to the gate electrode through the transmission line TG. Accordingly, the optical electric charges acquired by photoelectric conversion performed by the photoelectric conversion device 111 are transferred to the floating diffusion FD.

The reset transistor 113 has the drain electrode connected to the electric potential VDD of the power source and the source electrode connected to the floating diffusion FD. Thus, the reset transistor 113 is in the ON state by applying a high-active reset pulse LRST to the gate electrode through the reset line RST. Accordingly, the reset transistor 113 discards the electric charges of the floating diffusion FD to the electric potential VDD of the power source before transfer of the signal electric charges from the photoelectric conversion device 111 to the floating diffusion FD, thereby resetting the floating diffusion FD.

The amplifier transistor 114 has the gate electrode connected to the floating diffusion FD and the drain electrode connected to the electric potential VDD of the power source. The amplifier transistor 114 outputs the electric potential of the floating diffusion FD after being reset by the reset transistor 113 as a reset level. In addition, the amplifier transistor 114 outputs the electric potential of the floating diffusion FD after transfer of the signal electric charges through the transfer transistor 112 as a signal level.

The selection transistor 115, for example, has the drain electrode connected to the source of the amplifier transistor 114 and the source electrode connected to an output signal line 116. The selection transistor 115 is in the ON state by applying a high-active selection pulse LSEL to the gate through the selection line SEL. Accordingly, the selection transistor 115 relays the signal output from the amplifier transistor 114 to the output signal line 116 in the selection state of the pixel.

In addition, the configuration of the pixel is not limited to the configuration of the peripheral circuit that is formed by four transistors having the above-described configuration. Thus, a pixel configuration formed by three transistors in which the amplifier transistor 114 is used also as the selection transistor 115 may be used, and the configuration of the pixel circuit is not particularly limited.

### [Correction Value Calculating Unit]

In the solid-state imaging device of this embodiment, a correction value used for shading correction is calculated by the correction value calculating unit. The correction value calculating unit calculates the correction value by averaging pixel signals of a plurality of pixels disposed along the horizontal direction of the ineffective pixel portion among the pixel signals of the ineffective pixel portion that are read out for each column. In this embodiment, the arrangement direction of the column of pixels corresponds to the horizontal direction, and the arrangement direction of the row of pixels corresponds to the vertical direction.

The correction value is calculated by the correction value calculating unit for each column. In this embodiment, as calculation of the correction value corresponding to one column, the correction value is calculated by adding and averaging the pixel signal of the ineffective pixel portion (VOPB portion) corresponding to the corresponding column and the pixel signals of a plurality of ineffective pixel portions positioned along the horizontal direction. Accordingly, even when a noise such as a white dot is generated in the pixel signal of the ineffective pixel portion corresponding to one column, the component of the noise is scattered by averaging the pixel signal of the ineffective pixel portion and a plurality of pixel signals along the horizontal direction, whereby the influence of the noise on the shading correction can be suppressed.

In addition, the correction value calculating unit, as appropriate, calculates the correction value by averaging pixel signals of a plurality of pixels that are positioned along the horizontal direction of the ineffective pixel portion and the pixel signals of the plurality of pixels positioned along the vertical direction. In other words, as the VOPB portion that is the ineffective pixel portion, the plurality of ineffective pixel portions may be disposed in a same column. In such a case, the pixel signals of the plurality of ineffective pixel portions positioned in the same column are added and averaged so as to be an element of the correction value of the corresponding column. In addition, the element of the correction value of the corresponding column and the elements of the correction values of a plurality of columns positioned along the horizontal direction are added and averaged to be the correction value of the corresponding column. Accordingly, even when a noise is generated in the same column as a corresponding column, the component of the noise is scattered (the low pass filter effect) by averaging the noise and the elements of the plurality of correction values along the horizontal direction. As a result, the influence of the noise on the shading correction can be suppressed.

Here, the correction value calculating unit calculates the average of pixel signals of the plurality of pixels of the ineffective pixel portion (VOPB portion) disposed along the horizontal direction for each one vertical scanning period of the imaging unit.

Described in more detail, first, when the pixel signals of the ineffective pixel portion (VOPB portion) and the effective pixel portion are fetched and output for fetching an image corresponding to one frame, the elements of the correction values are calculated for each column based on the pixel signals of the ineffective pixel portion (VOPB portion).

In the calculating of the element of the correction value for each column, in a case where the number of pixels of the ineffective pixel portion (VOPB portion) disposed along the column direction is one, the pixel signal of the pixel directly becomes the element of the correction value. On the other hand, in a case where the number of pixels of the ineffective pixel portion (VOPB portion) disposed along the column direction is two or more, the element of the correction value is acquired by adding and averaging the pixel signals of the plurality of pixels disposed along the column direction.

Then, in the fetching of an image corresponding to the next one frame, similarly, the element of the correction value is calculated for each column based on the pixel signals of the ineffective pixel portion (VOPB portion). However, the element of the correction value for each column and the element of the correction value of a column, which is adjacent thereto in the horizontal direction, calculated in the previous frame are added and averaged. This process is repeated for a plurality of columns for each one frame.

When calculating the correction value of the ineffective pixel portion (VOPB portion) corresponding to one column, the correction value calculating unit averages the elements of the pixel signals of several pixels or several columns adjacent to the corresponding column used as its center in the horizontal direction. Accordingly, the noise component included in the ineffective pixel portion (VOPB portion) of the corresponding column can be scattered in the horizontal direction, whereby the influence of the noise component on the shading correction is suppressed.

When averaging the pixel signals of the plurality of pixels or the plurality of columns of the ineffective pixel portion (VOPB portion) disposed along the horizontal direction for each one vertical scanning period, the correction value calculating unit sequentially adds the elements of the pixel signals of the plurality of pixels or the plurality of columns, which are disposed in the horizontal direction, along one direction and averages the added elements. Alternatively, the correction value calculating unit sequentially adds the elements of the pixel signals of the plurality of pixels or the plurality of columns along two-way directions and averages the added elements.

### <2. Method of Driving Solid-State Imaging Device>

### [Read Timing of Pixel Signal]

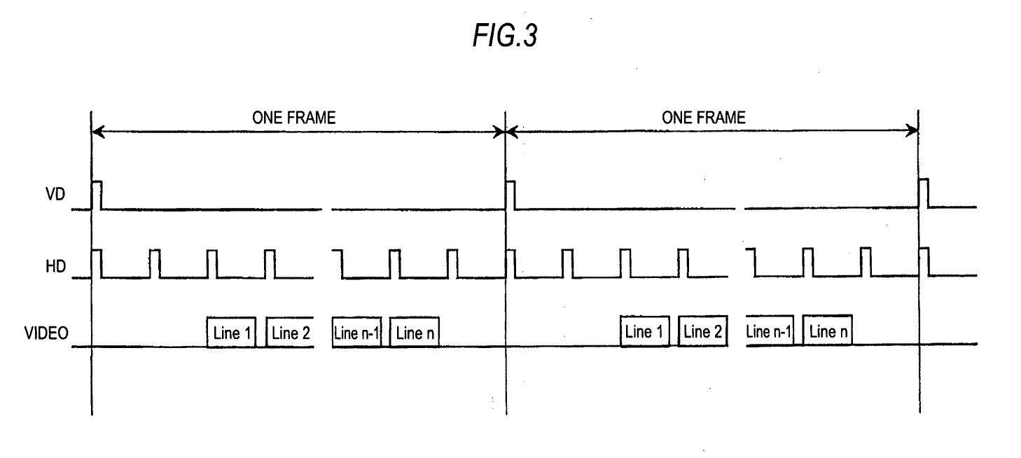

FIG. 3 is a timing chart illustrating the output timing of a pixel signal in a method of driving a solid-state imaging device according to this embodiment. The pixel signals fetched in the pixels of the imaging unit are output as signals corresponding to one frame in accordance with a vertical transmission signal VD. During the interval of the vertical transmission signal VD, a horizontal transmission signal HD corresponding to one row is generated, and signals corresponding to one row are output in accordance with the horizontal transmission signal HD. In other words, the pixel signals are output in the order of the first row, the second row, . . . , the (n-1)-th row, and the n-th row in accordance with the generation timings of the horizontal transmission signal HD. Here, n is the number of pixels of the imaging unit in the vertical direction.

Although not shown in FIG. 3, as output of signals for each row, pixel signals of the first row to the m-th row are sequentially output. Here, m is the number of pixels of the imaging unit in the horizontal direction.

In the output of the pixel signals corresponding to one frame and n rows, the first or the last pixel signals of one to several rows that are output first or last are pixel signals of the ineffective pixel portion (VOPB portion). The correction value calculating unit calculates a correction value for each column by using the pixel signals of the ineffective pixel portion (VOPB portion). Then, calculation of subtracting from the pixel signals of the effective pixel portion for each column the correction value of the same column is performed by the difference calculating unit so as to acquire a signal after the shading correction.

### [Method of Calculating Correction Value]

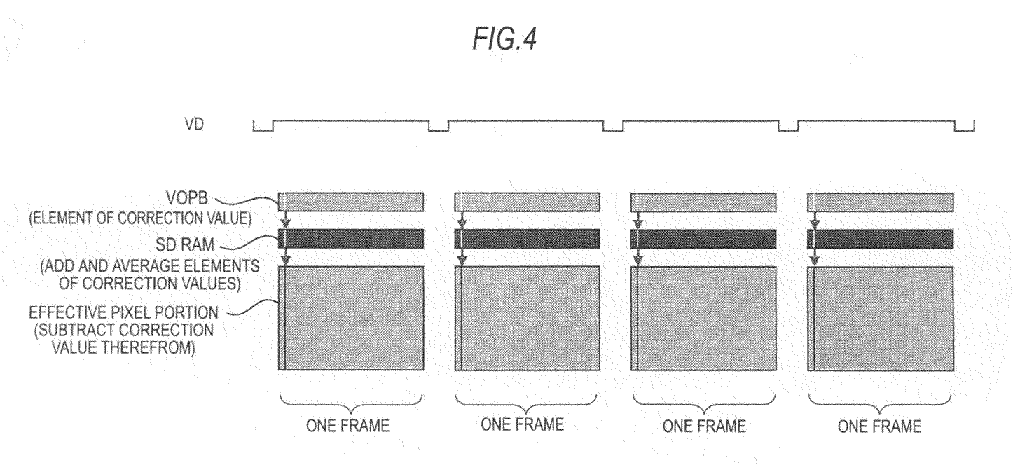

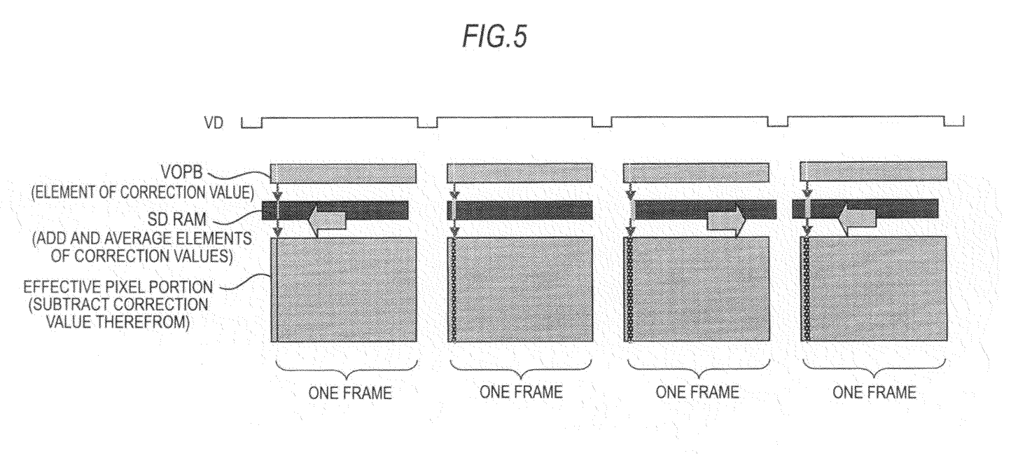

Next, a method of calculating a correction value will be described. Here, before the method of calculating a correction value according to this embodiment is described, a comparative example will be described. FIG. 4 is a schematic diagram illustrating a method of calculating a correction value according to a comparative example. FIG. 4 represents the states of the pixel signals of the ineffective pixel portion (VOPB portion) and the effective pixel portion during each one vertical transmission period (one frame) for four frames.

In reading out pixel signals of one frame, pixel signals of the ineffective pixel portion (VOPB portion) for each column are stored in a memory (SDRAM). At this time, in a case where there are a plurality of pixels in one column in the ineffective pixel portion (VOPB portion), the pixel signals of the plurality of pixels in one column are added together, and an average value thereof is stored in the memory (SDRAM). Then, when the pixel signals of each frame are sequentially read out, the time integrals of the pixel signals of the ineffective pixel portion (VOPB portion) are calculated, an average thereof is overwritten so as to be stored in the memory (SDRAM), and the average is set as the correction value (detected value of the vertical line) for each column. The pixel signals of the effective pixel portion are read out, and then, the correction value for each column is subtracted from the pixel signals, whereby vertical line shading correction is achieved.

Next, the method of calculating a correction value according to this embodiment will be described. FIG. 5 is a schematic diagram illustrating the method of calculating a correction value according to this embodiment. FIG. 5, similarly to FIG. 4, represents the states of the pixel signals of the ineffective pixel portion (VOPB portion) and the effective pixel portion during each one vertical transmission period (one frame) for four frames.

In this embodiment, similarly to the comparative example, the pixel signals of the ineffective pixel portion (VOPB portion) of each column are read out and stored in a memory (SDRAM) for each one frame. Here, the memory (SDRAM) is disposed in the signal processing circuit, an external signal processing circuit, or the like that is shown in FIG. 1. At this time, in a case where there are a plurality of pixels in one column in the ineffective pixel portion (VOPB portion), the pixel signals of the plurality of pixels disposed in one column are added together, and an average value thereof is stored in the memory (SDRAM).

In the storing of the pixel signal of the ineffective pixel portion (VOPB portion) in the memory (SDRAM), the time integral of the pixel signals stored in memory addresses of different columns disposed along the horizontal direction for each one frame are calculated, and an average value thereof is overwritten so as to be stored.

A detailed method is as follows. First, the pixel signals of the ineffective pixel portion (VOPB portion) are read out. At this time, the pixel signals are read out with the transmission signal TG shown in FIG. 2 in the ON state. Accordingly, the pixel signals are accumulated by performing the same operation as that of the effective pixel portion. Therefore, the influence such as shading due to a circuit operation or a read-out operation is avoided.

Next, in a case where there are a plurality of pixels in one column of the ineffective pixel portion (VOPB portion), the pixel signals of the plurality of pixels configuring one column are added together, and an average thereof is calculated. The pixel signal or the averaged pixel signal of the ineffective pixel portion (VOPB portion) is acquired for each one frame as the element of the correction value. Then, the pixel signal or the averaged pixel signal and the element of the correction value acquired in the previous frame are added together, and a new correction value that is acquired by calculating an average thereof is overwritten so as to be stored in the memory (SDRAM). As the calculation of the new correction value for each one frame, the pixel signals of the plurality of pixels (a plurality of columns) disposed in the horizontal direction are added for each one frame while shifting the address of the memory with the address of the memory that corresponds to a corresponding column of the ineffective pixel portion (VOPB portion) used as its center, and an average thereof is acquired.

Based on the calculation performed in the above-described process, the same advantage as that acquired in a case where a low pass filter is applied in the horizontal direction for the pixel signal of the ineffective pixel portion (VOPB portion) is acquired. Accordingly, even when a defect such as a white dots, a white sesame dot, or a fixed pattern noise is generated in the ineffective pixel portion (VOPB portion), the defect can be scattered.

In the above-described example, the pixel signals of the ineffective pixel portion (VOPB portion) are added and averaged while shifting the address of the memory (SDRAM) for each one frame. However, the same calculation result can be acquired by driving the column scanning circuit with the read-out start address shifted for each one frame. In such a case, the operation of the address of the memory (SDRAM) is not necessary.

### [Detailed Method of Column Addition]

Next, a detailed example of column addition will be described. Here, two examples in which pixel signals of a plurality of pixels or a plurality of columns of the ineffective pixel portion (VOPB portion) that are disposed along the horizontal direction are shifted in the horizontal direction so as to be added and averaged for each one vertical transmission period (one frame) will be described.

(1) Example in Which Elements of Pixel Signals Are Sequentially Added and Averaged in One Direction along Horizontal Direction

In this example, a column in which the pixel signals of the ineffective pixel portion (VOPB portion) are to be added is sequentially changed in one direction (same direction) along the horizontal direction for each one vertical transmission period (one frame). Here, a case where the target column of the ineffective pixel portion (VOPB portion) is assumed to be Column “0”, and pixel signals of two columns prior to and after the target column along the horizontal direction are added and averaged by shifting between the columns will be described as a detailed example. In addition, the operations described below are performed for each one vertical transmission period (one frame), and the operations are repeated. Any of the operations may be configured to be performed first. Here, the target column of Column “0” will be focused in the description below. However, the same addition process is performed for all the columns of the ineffective pixel portion (VOPB portion).

### (Operation 1)

For the next frame, the elements of the correction values are acquired based on pixel signals fetched in the ineffective pixel portion (VOPB portion) of Column “−2” that is two columns prior to Column “0” as a target column in the horizontal direction among the pixel signals fetched in the ineffective pixel portion (VOPB portion). Then, the elements of the correction values of Column “−2” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 2)

For the next frame, the elements of the correction values are acquired based on pixel signals fetched in the ineffective pixel portion (VOPB portion) of Column “−1” that is one column prior to Column “0” in the horizontal direction among the pixel signals fetched in the ineffective pixel portion (VOPB portion). Then, the elements of the correction values of Column “−1” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 3)

For the next frame, the elements of the correction values are acquired based on pixel signals fetched in the ineffective pixel portion (VOPB portion) of Column “0” among the pixel signals fetched in the ineffective pixel portion (VOPB portion). Then, the acquired elements of the correction values of Column “0” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 4)

For the next frame, the elements of the correction values are acquired based on pixel signals fetched in the ineffective pixel portion (VOPB portion) of Column “+1” that is one column after Column “0” in the horizontal direction among the pixel signals fetched in the ineffective pixel portion (VOPB portion). Then, the elements of the correction values of Column “+1” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 5)

For the next frame, the elements of the correction values are acquired based on pixel signals fetched in the ineffective pixel portion (VOPB portion) of Column “+2” that is two columns after Column “0” in the horizontal direction among the pixel signals fetched in the ineffective pixel portion (VOPB portion). Then, the elements of the correction values of Column “+2” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

When the process proceeds up to Operation 5 described above, the process is returned to Operation 1 described above, and the operations thereafter are sequentially repeated. In other words, when the order of the columns of which the pixel signals are to be added to those of Column “0” as the target column are represented by the column numbers, “−2”=>“−1”=>“0”=>“+1”=>“+2” forms one cycle, and the sequence is repeated.

(2) Example in Which Elements of Pixel Signals Are Sequentially Added and Averaged in Forward and Backward Directions along Horizontal Direction

In this example, a column in which the pixel signals of the ineffective pixel portion (VOPB portion) are to be added is sequentially changed in forward and backward directions along the horizontal direction for each one vertical transmission period (one frame). Here, a case where the target column of the ineffective pixel portion (VOPB portion) is assumed to be Column “0”, and pixel signals of two columns prior to and after the target column along the horizontal direction are added and averaged by shifting between the columns will be described as a detailed example. In addition, the operations described below are performed for each one vertical transmission period (one frame), and the operations are repeated. Any of the operations may be configured to be performed first. Here, the target column of Column “0” will be focused in the description below. However, the same addition process is performed for all the columns of the ineffective pixel portion (VOPB portion).

### (Operation 1)

For the next frame, the elements of the correction values are acquired based on pixel signals fetched in the ineffective pixel portion (VOPB portion) of Column “−2” that is two columns prior to Column “0” as a target column in the horizontal direction among the pixel signals fetched in the ineffective pixel portion (VOPB portion). Then, the elements of the correction values of Column “−2” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 2)

For the next frame, the elements of the correction values are acquired based on pixel signals fetched in the ineffective pixel portion (VOPB portion) of Column “−1” that is one column prior to Column “0” in the horizontal direction among the pixel signals fetched in the ineffective pixel portion (VOPB portion). Then, the elements of the correction values of Column “−1” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 3)

For the next frame, the elements of the correction values are acquired based on pixel signals fetched in the ineffective pixel portion (VOPB portion) of Column “0” among the pixel signals fetched in the ineffective pixel portion (VOPB portion). Then, the elements of the correction values of Column “0” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 4)

For the next frame, the elements of the correction values are acquired based on pixel signals fetched in the ineffective pixel portion (VOPB portion) of Column “+1” that is one column after Column “0” in the horizontal direction among the pixel signals fetched in the ineffective pixel portion (VOPB portion). Then, the elements of the correction values of Column “+1” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 5)

For the next frame, the elements of the correction values are acquired based on pixel signals fetched in the ineffective pixel portion (VOPB portion) of Column “+2” that is two columns after Column “0” in the horizontal direction among the pixel signals fetched in the ineffective pixel portion (VOPB portion). Then, the elements of the correction values of Column “+2” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 6)

For the next frame, the elements of the correction values are acquired based on pixel signals fetched in the ineffective pixel portion (VOPB portion) of Column “+1” that is one column after Column “0” in the horizontal direction among the pixel signals fetched in the ineffective pixel portion (VOPB portion). Then, the elements of the correction values of Column “+1” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 7)

For the next frame, the elements of the correction values are acquired based on pixel signals fetched in the ineffective pixel portion (VOPB portion) of Column “0” among the pixel signals fetched in the ineffective pixel portion (VOPB portion). Then, the acquired elements of the correction values of Column “0” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

### (Operation 8)

For the next frame, the elements of the correction values are acquired based on pixel signals fetched in the ineffective pixel portion (VOPB portion) of Column “−1” that is one column prior to Column “0” in the horizontal direction among the pixel signals fetched in the ineffective pixel portion (VOPB portion). Then, the elements of the correction values of Column “−1” and the elements of the correction values stored at the addresses of the memory (SDRAM) corresponding to Column “0” are added together, an average thereof is acquired, and the average is overwritten at an address of the memory (SDRAM) corresponding to Column “0” so as to be stored therein.

When the process proceeds up to Operation 8 described above, the process is returned to Operation 1 described above, and the operations thereafter are sequentially repeated. In other words, when the order of the columns of which the pixel signals are to be added to those of Column “0” as the target column is represented by the column numbers, “−2”=>“−1”=>“0”=>“+1”=>“+2”=>“+1”=>“0”=>“−1” forms one cycle, and the sequence is repeated.

In the examples of the addition methods shown under the sections “(1)” and “(2)”, examples have been shown in which pixel signals of two columns, which are disposed in the horizontal direction, prior to and after Column “0” as the target column positioned on the center are sequentially added, and an average thereof is calculated. However, for example, the pixel signals of 3 to 127 columns prior to and after the target column and the pixel signals of the target column may be added together and averaged, and more preferably, the pixel signals of 15 columns prior to and after the target column and the pixel signals of the target column may be added together and averaged.

In the example of the addition method shown under the section “(2)”, the number of times of addition of the columns of the plurality of columns, in which the pixel signals are to be added, that are positioned on both ends is smaller than that in the addition method shown under the section “(1)”. Accordingly, the noise reduction effect (the low pass filter effect) is higher in the addition method described under the section “(1)” than in that described under the section “(2)”. In addition, in a case where there is a vertical line remaining after the shading correction, the viewing patterns are different in the examples shown under the sections “(1)” and “(2)”. In the example shown under the section “(1)”, the remaining vertical line appears to have a fixed width along the vertical direction in a specific direction. On the other hand, in the example shown under the section “(2)”, the remaining vertical line appears along the vertical direction so as to be horizontally repeated in forward and backward directions in a fixed width.

### <3. Electronic Apparatus>

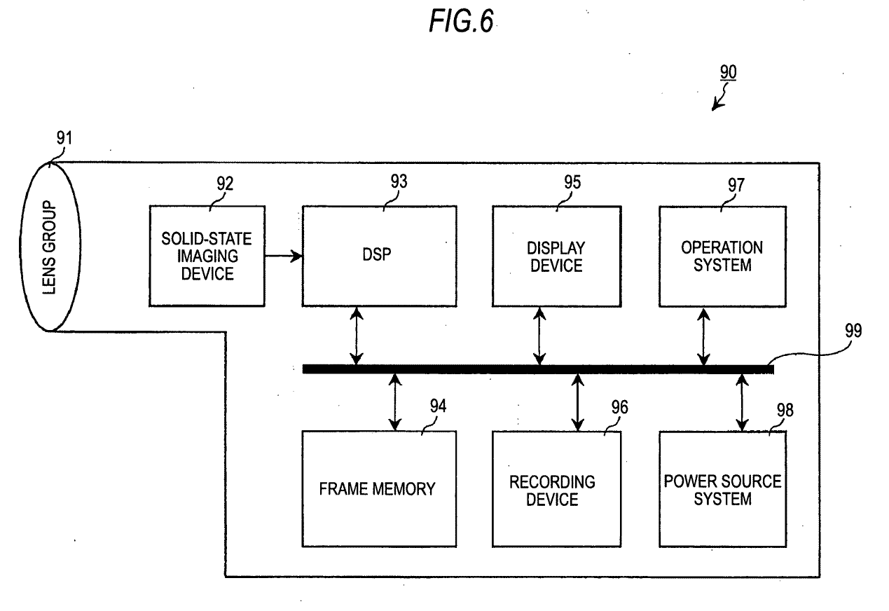

FIG. 6 is a block diagram showing a configuration example of an imaging apparatus as an example of an electronic apparatus according to this embodiment. As shown in FIG. 6, the imaging apparatus 90 includes an optical system that includes a lens group 91, a solid-state imaging device 92, a DSP (Digital Signal Processor) circuit 93 that is a camera signal processing circuit, a frame memory 94, a display device 95, a recording device 96, an operation system 97, a power source system 98, and the like. The DSP circuit 93, the frame memory 94, the display device 95, the recording device 96, the operation system 97, and the power source system 98 are configured to be interconnected with one another through a bus line 99.

The lens group 91 fetches incident light (image light) transmitted from a subject and forms an image of the subject on an imaging surface of the solid-state imaging device 92. The solid-state imaging device 92 converts the amount of the incident light imaged on the imaging surface by the lens group 91 into electric signals in units of pixels and outputs the electric signals as pixel signals. As the solid-state imaging device 92, the above-described solid-state imaging device of this embodiment is used.

The display device 95 is configured by a panel-type display device such as a liquid crystal display device or an organic EL (electro luminescence) display device. The display device 95 displays a moving picture or a still image that is formed by the solid-state imaging device 92. The recording device 96 records the moving picture or the still image that is formed by the solid-state imaging device 92 on a recording medium such as a non-volatile memory, a video tape, or a DVD (Digital Versatile Disk).

The operation system 97 issues operation commands for various functions included in the imaging apparatus under a user's operation. The power source system 98 appropriately supplies various types of power that become operation power sources of the DSP circuit 93, the frame memory 94, the display device 95, the recording device 96, and the operation system 97 to supply targets.

The imaging apparatus 90 is applied to a video camera, a digital still camera, or a camera module for a mobile device such as a cellular phone. By using the above-described solid-state imaging device of this embodiment as the solid-state imaging device 92, a high quality imaging apparatus capable of suppressing noise can be provided.

In the above-described embodiment, an example in which a CMOS type is mainly used as the solid-state imaging device has been described. However, a CCD (Charge Coupled Devices) type solid-state imaging device may be used. In addition, when a correction value is acquired by adding and averaging the pixel signals of different columns along the horizontal direction, the weighting factor may be configured to be decreased as the column is located farther from the target column along the horizontal direction. In addition, in this embodiment, the correction value for the H (Horizontal) shading correction is acquired by using the VOPB portion that is an ineffective pixel portion disposed along the horizontal direction. However, the same concept may be applied to V (Vertical) shading correction. In other words, in such a case, an HOPB (optical black for the H (Horizontal) direction) portion, which is disposed along the vertical direction in the end portion in the horizontal direction, of the ineffective pixel portion is used. Then, the correction value for the V (Vertical) shading correction may be acquired by using the average (in this case, an average using pixel signals of different rows along the vertical direction) as described above.

The present application contains subject matter related to that disclosed in Japanese Priority Patent Application JP 2009-186249 filed in the Japan Patent Office on Aug. 11, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A solid-state imaging device comprising:
an imaging unit, in which a plurality of unit pixels each including a photoelectric conversion device are disposed in a two-dimensional shape, that has an effective pixel portion in which light is incident to the photoelectric conversion device and an ineffective pixel portion in which light is not incident to the photoelectric conversion device;
a pixel-signal reading circuit unit that reads out a pixel signal acquired by the imaging unit;
a correction value calculating unit that calculates a correction value for the pixel signals of the ineffective pixel portion for each column that are read out by the pixel-signal reading circuit unit by averaging the pixel signals of a plurality of pixels that are disposed along a horizontal direction of the ineffective pixel portion; and
a difference calculating unit that subtracts the correction value corresponding to a column of the effective pixel portion, which is calculated by the correction value calculating unit, from the pixel signal of the effective pixel portion that is read out by the pixel-signal reading circuit unit.

2. The solid-state imaging device according to claim 1, wherein the correction value calculating unit calculates the correction value by averaging the pixel signals of a plurality of pixels disposed along the horizontal direction of the ineffective pixel portion and a plurality of pixels disposed along a vertical direction of the ineffective pixel portion.

3. The solid-state imaging device according to claim 1, wherein the correction value calculating unit calculates an average of the pixel signals of a plurality of pixels disposed along the horizontal direction of the ineffective pixel portion for each one vertical scanning period of the imaging unit.

4. The solid-state imaging device according to claim 1, wherein the correction value calculating unit calculates an average of the pixel signals of several pixels that are vertically adjacent along the horizontal direction with one column of the ineffective pixel portion used as a center of the several pixels.

5. The solid-state imaging device according to claim 4, wherein the correction value calculating unit calculates the average by sequentially adding the pixel signals in one direction of a plurality of pixels disposed along the horizontal direction of the ineffective pixel portion for each one vertical scanning period of the imaging unit.

6. The solid-state imaging device according to claim 3, wherein the correction value calculating unit calculates the average by sequentially adding the pixel signals in forward and backward directions of a plurality of pixels disposed along the horizontal direction of the ineffective pixel portion for each one vertical scanning period of the imaging unit.

7. A method of driving a solid-state imaging device, the method comprising the steps of:
acquiring a pixel signal by using an imaging unit, in which a plurality of unit pixels each including a photoelectric conversion device are disposed in a two-dimensional shape, that has an effective pixel portion in which light is incident to the photoelectric conversion device and an ineffective pixel portion in which light is not incident to the photoelectric conversion device;
calculating a correction value by reading out the pixel signals acquired by the ineffective pixel portion of the imaging unit and averaging the pixel signals of a plurality of pixels disposed along a horizontal direction of the ineffective pixel portion; and
reading out the pixel signals acquired by the effective pixel portion of the imaging unit and subtracting the correction value corresponding to a corresponding column of the effective pixel portion from the pixel signals.

8. The method according to claim 7, wherein, in the calculating of a correction value, an average of the pixel signals of a plurality of pixels disposed along the horizontal direction of the ineffective pixel portion is calculated for each one vertical scanning period of the imaging unit.

9. The method according to claim 7, wherein, in the calculating of a correction value, when the pixel signals acquired by the ineffective pixel portion of the imaging unit are read out, an average is calculated by reading out the pixel signals of different ineffective pixel portions along the horizontal direction of the ineffective pixel portion for each one horizontal scanning period of the imaging unit and adding the pixel signals and the pixel signal of the ineffective pixel portion that is previously read.

10. The method according to claim 7, wherein, in the calculating of a correction value, when the pixel signals acquired in the ineffective pixel portion corresponding to one column of the imaging unit are read out and are stored in a memory unit, an average is calculated by adding the pixel signals acquired in the ineffective pixel portion corresponding to the one column and storing the added pixel signals in an area used for storing the pixel signals acquired in different ineffective pixel portions along the horizontal direction of the ineffective pixel portion by controlling an address of a storage destination of the memory unit for each one horizontal scanning period of the imaging unit.

11. The method according to claim 7, wherein, in the calculating of a correction value, an average is calculated by sequentially adding the pixel signals in one direction of a plurality of pixels disposed along the horizontal direction of the ineffective pixel portion for each one vertical scanning period of the imaging unit.

12. The method according to claim 7, wherein, in the calculating of the correction value, an average is calculated by sequentially adding the pixel signals in forward and backward directions of a plurality of pixels disposed along the horizontal direction of the ineffective pixel portion for each one vertical scanning period of the imaging unit.

13. An electronic apparatus comprising:
a solid-state imaging device that converts fetched light into an electrical signal; and
a signal processing unit that processes the electrical signal acquired by the solid-state imaging device,
wherein the solid-state imaging device includes
an imaging unit, in which a plurality of unit pixels each including a photoelectric conversion device are disposed in a two-dimensional shape, that has an effective pixel portion in which light is incident to the photoelectric conversion device and an ineffective pixel portion in which light is not incident to the photoelectric conversion device,
a pixel-signal reading circuit unit that reads out a pixel signal acquired by the imaging unit,
a correction value calculating unit that calculates a correction value for the pixel signals of the ineffective pixel portion for each column that are read out by the pixel-signal reading circuit unit by averaging the pixel signals of a plurality of pixels that are disposed in a horizontal direction of the ineffective pixel portion; and
a difference calculating unit that subtracts the correction value corresponding to a column of the effective pixel portion, which is calculated by the correction value calculating unit, from the pixel signal of the effective pixel portion that is read out by the pixel-signal reading circuit unit.
